(19) United States
(12) Patent Application Publication
(10) Pub. No.: US 2008/0013726 A1
(43) Pub. Date: Jan. 17, 2008

(54) CONTENT TRANSMISSION SERVER AND CONTENT TRANSMISSION METHOD

(75) Inventors: Shinobu Kuriya, Kanagawa (JP); Tsuyoshi Masato, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/769,461

(22) Filed: Jun. 27, 2007

(30) Foreign Application Priority Data
Jun. 30, 2006 (JP) P2006-182028

(51) Int. Cl. H04N 7/167

(52) U.S. Cl. 380/210

(57) ABSTRACT

A content transmission server which records encrypted streaming data of a predetermined unit to which time information is added and transmits the encoded streaming data to a client, includes: a decryption section; a local encryption section; a storage section; and a transmission section. The decryption section is configured to decrypt the encrypted streaming data of the predetermined unit to which the time information is added. The local encryption section is configured to locally encrypt the streaming data decrypted by the decryption section. The storage section is configured to store the streaming data locally encrypted by the local encryption section. The transmission section is configured to transmit the encrypted streaming data to the client.

### CROSS REFERENCE TO RELATED APPLICATIONS

The present application claims priority to Japanese Patent Application JP 2006-182028 filed with the Japan Patent Office on Jun. 30, 2006, the entire contents of which is being incorporated herein by reference.

### BACKGROUND

The present application relates to a content transmission server and a content transmission method for transmitting a content to a client.

In recent years, a digital content of public broadcasting or digital broadcasting on the Internet is placed under the copyright protection. For example, where a broadcasting content is under the copyright protection by the CGMS-A (Copy Generation Management System/Analog), it is necessary to place the broadcasting content under the copyright protection also in re-transmission within a home. Therefore, a home server apparatus with a broadcast recording function which records a broadcasting content under the copyright protection and re-transmits the broadcasting content to another home apparatus or an apparatus which receives and stores a content from a home server apparatus with a broadcast recording function through a home network and then re-transmits the content to another home apparatus encrypts (DES, Triple-DES, AES or the like) and stores a copyright-protected content using a key unique to the apparatus. Then, upon transmission, the apparatus re-encrypts the copyright-protected content, for example, by the DTCP-IP (Digital Transmission Contents Protection over IP) or the like and then re-transmits the re-encrypted content. The apparatus of the type just described is disclosed, for example, in Japanese Patent Laid-open No. 2002-261748.

In recent years, the DLNA (Digital Living Network Alliance) directed to sharing of contents within a home network (LAN: Local Area Network) established and popularized standards. In such environments, various cases wherein contents are requested in various forms to apparatus in homes are prescribed. For example, the byte-base-seek for designating a bite size of a file, the time-base-seek for designating time and so forth when a client performs seeking for a moving picture content to a server through a home LAN are prescribed.

However, if a content stored in a server apparatus is a copyright-managed content in which a timestamp such as a Timed TS is inserted at fixed intervals, then if a client (content reproduction apparatus) issues a request for the time base seek to the server, then the server has to decrypt the entire content in order to acquire time information of the content. This deteriorates the performance in seeking.

Therefore, it is demanded to provide a content transmission server and a content transmission method which can transmit a content at a desired position quickly in response to a seek request from a client.

### SUMMARY

According to an embodiment, there is provided a content transmission server which records encrypted streaming data of a predetermined unit to which time information is added and transmits the encoded streaming data to a client, including: a decryption section; a local encryption section; a storage section; and a transmission section. The decryption section is configured to decrypt the encrypted streaming data of the predetermined unit to which the time information is added. The local encryption section is configured to locally encrypt the streaming data decrypted by the decryption section. The storage section is configured to store the streaming data locally encrypted by the local encryption section. The transmission section is configured to transmit the encrypted streaming data to the client. The local encryption section partially encrypts, when the local encryption section stores the encrypted streaming data as encrypted streaming data for transmission into the storage section, a portion of the partially encrypted streaming data stored in the storage section other than the time information using an apparatus unique key. The storage section stores the partially encrypted streaming data and the time information. The transmission section searches in response to a request for encrypted streaming data at a desired time position from the client, the partially encrypted streaming data stored in the storage section based on the time information, partially decrypts the partially encrypted streaming data at the desired time position using the information unique key, re-encrypts the partially decrypted streaming data with a predetermined protocol and transmits the encrypted streaming data to the client.

According to another embodiment, there is provided a content transmission method for recording encrypted streaming data of a predetermined unit to which time information is added and transmitting the encoded streaming data to a client, including the steps of: decrypting; locally encrypting; storing; and transmitting. The decryption step decrypts the encrypted streaming data of the predetermined unit to which the time information is added. The local encryption step locally encrypts the streaming data decrypted by the decryption step. The storage step stores the streaming data locally encrypted by the local encryption step into a storage section. The transmitting step transmits the encrypted streaming data to the client. The local encryption step includes partial encrypting, when the encrypted streaming data is stored as encrypted streaming data for transmission into the storage section, of a portion of the partially encrypted streaming data stored in the storage section other than the time information using an apparatus unique key. The storage step includes storage of the partially encrypted streaming data and the time information. The transmission step includes searching, in response to a request for encrypted streaming data at a desired time position from the client, of the partially encrypted streaming data stored in the storage section based on the time information, partial decryption of the partially encrypted streaming data at the desired time position using the information unique key, re-encryption of the partially decrypted streaming data with a predetermined protocol and transmission of the encrypted streaming data to the client.

In the content transmission server and the content transmission method, when encrypted streaming data are to be stored as encrypted streaming data for transmission into the storage section, a portion of the streaming data, to which time information is added, other than the time information is partially encrypted using the apparatus unique key and stored into the storage section. Then, in response to a request for the encrypted streaming data at a desired time position from the client, the partially encrypted streaming data stored in the storage section are searched based on the time information. Consequently, the content at the desired position can be transmitted rapidly in response to the seek request from the client.

Additional features and advantages are described herein, and will be apparent from, the following Detailed Description and the figures.

### BRIEF DESCRIPTION OF THE FIGURES

FIG. 1 is a block diagram showing a content transmission system according to an embodiment;

FIG. 2 is a diagrammatic view illustrating an example of an MPEG2-TS packet stream with a timestamp used in the content transmission system;

FIG. 3 is a block diagram showing a hardware configuration of a receiving server, a transmission server and a client in the content transmission system;

FIG. 4 is a block diagram showing a functional configuration of the transmission server;

FIG. 5 is a block diagram showing a functional configuration of a cryptography processing function of the transmission server;

FIG. 6 is a block diagram showing a functional configuration of the receiving server;

FIG. 7 is a block diagram showing a functional configuration of the client;

FIG. 8 is a flow diagram illustrating a sequence of operations when the transmission server acquires a Timed TS from the receiving server;

FIG. 9 is a similar view but illustrating a sequence of operations when the transmission server transmits a content to the client;

FIG. 10 is a diagrammatic view illustrating a relationship between a TS with a timestamp and a PES;

FIG. 11 is a block diagram showing a functional configuration of a transmission server with a decoding function;

FIG. 12 is a flow diagram illustrating a sequence of operations when the transmission server with a decoding function acquires a Timed TS from the receiving server;

FIG. 13 is a similar view but illustrating a sequence of operations when the transmission server with a decoding function transmits a content to the client; and

FIG. 14 is a similar view but illustrating a sequence of operations when the transmission server acquires a Timed TS from the receiving server.

### DETAILED DESCRIPTION

A detailed description will follow with reference to the figures according to various embodiments.

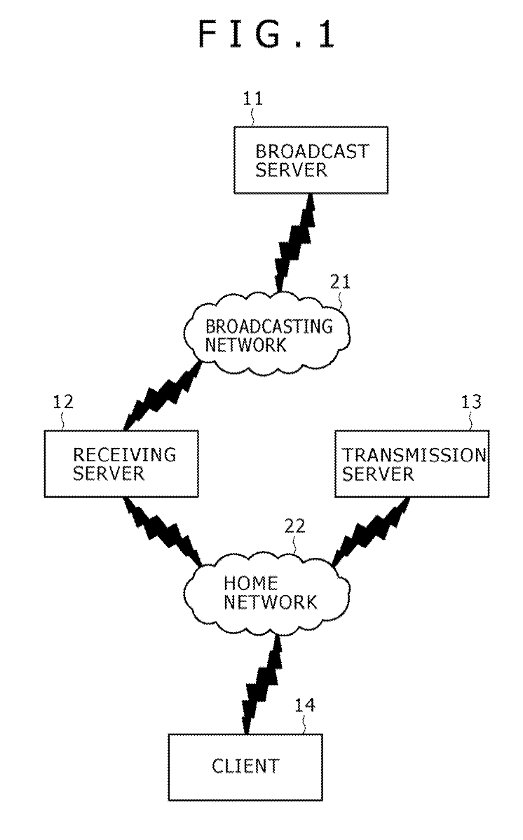

FIG. 1 shows a content transmission system according to an embodiment. Referring to FIG. 1, the content transmission system includes a broadcast server 11, a receiving server 12, a transmission server 13 and a client 14. The broadcast server 11 and the receiving server 12 are connected to each other by a broadcasting network 21 while the receiving server 12, transmission server 13 and client 14 are connected to each other through a home network 22 such as a LAN (Local Area Network).

The broadcast server 11 transmits a content to the receiving server 12 through broadcasting. The receiving server 12 receives and stores the content from the broadcast server 11 and sends the content to another apparatus in a home such as, for example, the transmission server 13 or the client 14 through the home network 22. The transmission server 13 receives the content from another server in the home such as, for example, the receiving server 12 and partially encrypts the content as hereinafter described. Further, the transmission server 13 stores a result of the partial encryption and re-transmits it to another server in the home such as, for example, the receiving server 12 or to the client 14. The client 14 is a client apparatus which acquires and reproduces a content from the receiving server 12 or the transmission server 13.

It is to be noted that the transmission server 13 may have a reception function of the receiving server 12, or the receiving server 12 may have a partial encryption function of the transmission server 13. Therefore, the receiving server 12 and the transmission server 13 may be formed as a single server to construct a network.

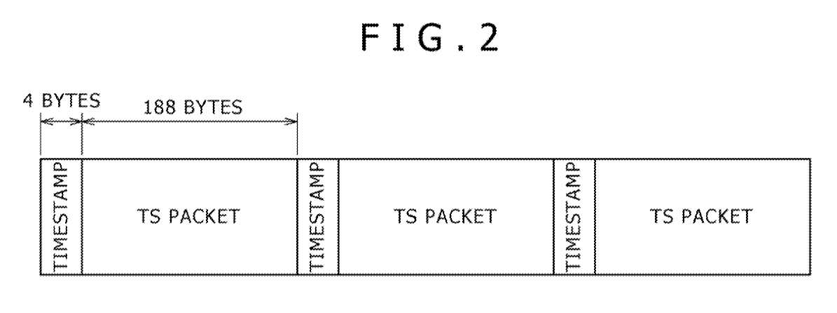

FIG. 2 illustrates an example of a stream (MPEG2-TS packet stream) wherein a TS (Transport Stream) packet (hereinafter referred to also as TTS packet) with a timestamp (Time Stamp) successively appears. The stream (Timed TS) includes repetitions of a TTS packet of 192 bytes formed by adding a timestamp of 4 bytes to a TS packet of a fixed length of 188 bytes. The receiving server 12 receives the stream from the transmission server 13.

The timestamp has time information represented by a count value of a clock such as a DTS (Decoding Time Stamp) for performing a decoding operation or a PTS (Presentation Time Stamp) for performing reproduction. Further, the timestamp transfers a clock reference to control a PLL (Phase Locked Loop) so that the timing may coincide between the sending side and the reception side. The reference clock number is, for example, 27 MHz, and an SCR (System Clock Reference) and a PCR (Program Clock Reference) in a unit of a program are available.

The TS packet has a TP header of 4 bytes, in which, for example, copy control information representative of whether or not copy is permitted is described for the copyright protection. The copy control information includes a flag which represents copy allowed which indicates that copy is permitted without any restriction, copy once which indicates that copy is performed by only one generation and copy prohibited which indicates that copy is prohibited. Where copy is permitted by only one generation, it is permitted to store received broadcast data once, but it is not permitted to separately produce a copy of the stored broadcast data. Accordingly, it is prohibited to store broadcast data, for example, on a hard disk and then write out the stored broadcast data on a DVD (Digital Versatile Disk). However, it is permitted not to copy but move data, and if operation of deleting a file on the hard disk after the file is written out to a DVD is performed, then the movement is permitted.

In the present embodiment, content data sent from the broadcast server 11 includes description of copy control information representing that, for example, the content data can be coped by only one generation. Thus, when the receiving server 12 or the transmission server 13 tries to store the content data, it locally encrypts the content data with a key unique to the apparatus and then records the encrypted content data. For the encryption technique, the DES (Data Encryption Standard) or the Triple DES of a secret key encryption algorithm, the AES (Advanced Encryption Standard) which divides a key into a block and then encrypts the blocked key and so forth can be used.

The transmission server 13 in the present embodiment receives a content from the receiving server 12 and decodes the content based on a predetermined transmission system (scramble of a broadcast, DTCP-IP or the like). In this instance, while re-encryption (DES, AES, Triple DES or the like) of the content is performed for the storage, a timestamp portion of a TTS packet (Timed TS) is stored without being encrypted.

Then, the transmission server 13 re-transmits a content for which a request has been received from the client 14 using a predetermined protocol (for example, Upnp AV, HTTP, DTCP-IP or the like). At this time, where the request from the client 14 includes designation of a time position at which, for example, the TimeSeekRange.DLNA.org.HTTP header defined by the DLNA or the like is to be reproduced, the transmission server 13 seeks a timestamp portion which is not in an encrypted state to specify a desired position. Then, the transmission server 13 decrypts the encrypted portion and re-encrypts the decrypted portion for transfer and then transmits the re-encrypted portion to the client 14.

The transmission server 13 decrypts the received encrypted content to which timestamps are added in accordance with protocol specifications (DTCP-IP or the like) and then partially encrypts the decrypted content (encrypts except the timestamp portions). Consequently, when the content is to be re-transmitted in response to the time base seek request from the client 14, the transmission server 13 can transmit a content at the requested position rapidly and with a high degree of accuracy.

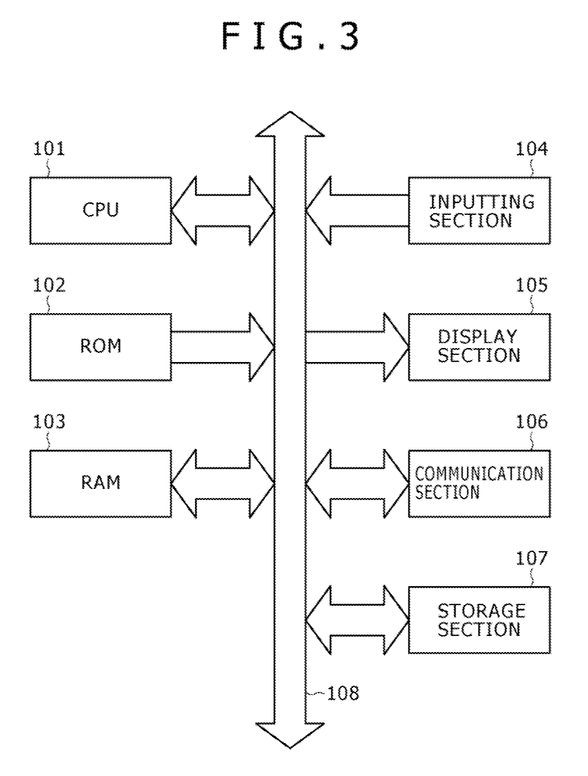

FIG. 3 shows a hardware configuration of the receiving server 12, transmission server 13 and client 14 described hereinabove. The receiving server 12, transmission server 13 and client 14 can be formed so as to have such a configuration of a computer apparatus as shown in FIG. 3. In particular, referred to FIG. 3, the receiving server 12, transmission server 13 and client 14 include a central processing unit (CPU) 101, a read only memory (ROM) 102, a random access memory (RAM) 103, an inputting section 104, a display section 105, a communication section 106 and a storage section 107 which are connected to each other by a bus 108.

The CPU 101 executes various functions stored in the ROM 102 or the RAM 103. The inputting section 104 includes inputting keys, a mouse and so forth. The display section 105 is formed from, for example, a liquid crystal display apparatus or the like and displays various kinds of information in the form of a text or an image. The communication section 106 sends data received from the opposite party of communication to the CPU 101, RAM 103, storage section 107 or the like. The storage section 107 communicates information with the CPU 101 to store or erase information.

It is to be noted here that, while such a computer apparatus as shown in FIG. 3 executes a program to perform a series of processes hereinafter described, the processes may otherwise be executed by hardware for exclusive use.

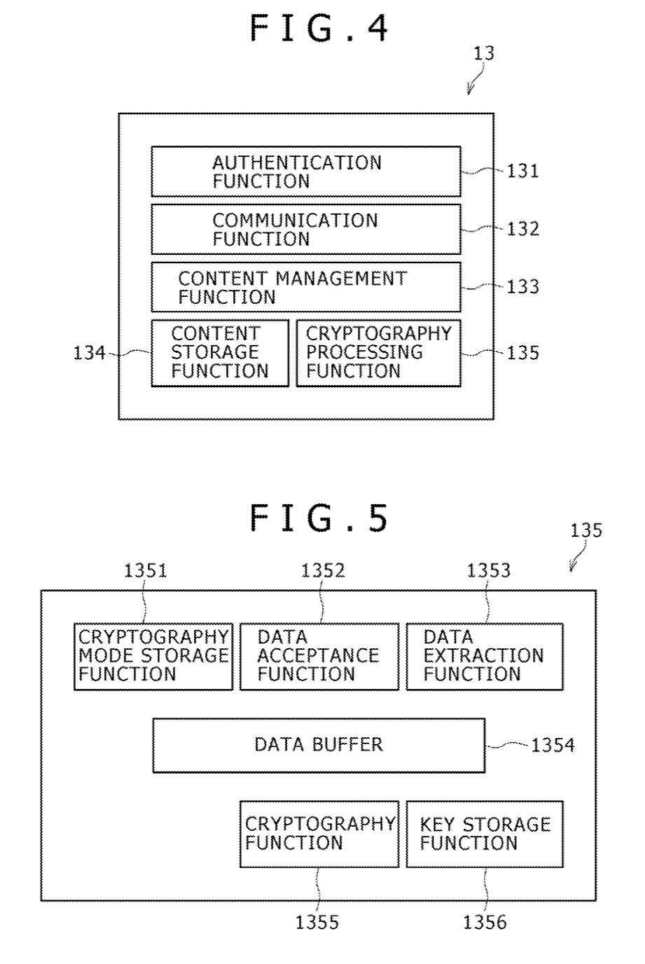

FIG. 4 shows a configuration of the transmission server 13. Referring to FIG. 4, the transmission server 13 includes an authentication function 131, a communication function 132, a content management function 133, a content storage function 134 and a cryptography processing function 135.

The authentication function 131 performs an authentication process together with the receiving server 12 or the client 14. After the authentication comes to an end, the authentication function 131 shares a session key with the opposite party of communication and passes the session key to the cryptography processing function 135. It is to be noted that a key and a certificate used for such authentication such as the RSA (Rivest Shamir Adleman), EC (Electronic Commerce) and so forth of the public key cryptography are embedded in the apparatus at a point of time of commercialization.

The communication function 132 receives a message from the receiving server 12 or the client 14 and passes an authentication message to the authentication function 131 but passes any other message to the content management function 133. Further, the communication function 132 sends a message received from the authentication function 131 or the content management function 133 to the receiving server 12 or the client 14.

The content management function 133 exchanges a message with the receiving server 12 or the client 14 through the communication function 132 and performs a process in response to the message. For example, when the content management function 133 tries to acquire content data as content data for transmission from the receiving server 12, it issues an instruction to the cryptography processing function 135 to perform partial encryption of the content data in response to the message.

The content storage function 134 performs reading out or writing of information in response to a request from the content management function 133.

The cryptography processing function 135 encrypts or decrypts information in response to a request from the content management function 133. A key unique to the apparatus is used as the key upon such encryption or decryption. Further, in response to a request from the content management function 133, the cryptography processing function 135 performs partial encryption by which a timestamp portion is not encrypted or decrypted in response to a request from the content management function 133. A key for encryption or decryption to be used in communication of data with another apparatus is acquired by the authentication function 131. It is to be noted that a key for encryption or decryption (DES, Triple-DES, AES or the like) of content data is embedded in the apparatus upon commercialization or is produced uniquely to the client 14 using a Hash function or the like from an apparatus ID embedded in the apparatus upon commercialization.

FIG. 5 shows a configuration of the cryptography processing function 135. Referring to FIG. 5, the cryptography processing function 135 includes an cryptography mode storage function 1351, a data acceptance function 1352, a data extraction function 1353, a data buffer 1354, a cryptography function 1355 and a key storage function 1356.

The cryptography mode storage function 1351 receives and stores a cryptography mode from the outside such as the content management function 133. The cryptography mode storage function 1351 stores, upon extraction of raw data for storage, transmission or reproduction by the apparatus itself, whether content data stored in the content storage function 134 is in an entire cryptography mode wherein the apparatus unique key is used or in a partial encryption mode.

The data acceptance function 1352 receives partial data (multiple of a Timed TS or the like) from an external function such as the content storage function and writes the received partial data into the data buffer 1354. Further, the data acceptance function 1352 issues an instruction to start encryption/decryption in accordance with the mode of the cryptography mode storage function 1351 to the cryptography function 1355 upon completion of inputting of data.

The data extraction function 1353 extracts partial data (multiple of a Timed TS or the like) whose cryptographic process is completed from the data buffer 1354 and passes the extracted partial data to an external function such as the content storage function.

The data buffer 1354 temporarily stores data of an object of encryption or decryption.

The cryptography function 1355 performs an encryption process and a decryption process in response to the cryptography mode of the cryptography mode storage function 1351. For example, upon storage of content data, the cryptography function 1355 decrypts the content data with a session key acquired from the authentication function 131 and encrypts the decrypted content data with the apparatus unique key. On the other hand, upon transmission of content data, the cryptography function 1355 decrypts the content data with the apparatus unique key and then encrypts the decrypted content key with a session key. Further, upon extraction of raw data for reproduction by the apparatus itself or the like, the cryptography function 1355 decrypts the content data with the apparatus unique key. Here, when the apparatus unique key is used for encryption or decryption, the cryptography function 1355 performs encryption or decryption except timestamp portions in the data buffer 1354. It is to be noted that the apparatus unique key is acquired from the key storage function 1356.

The key storage function 1356 stores the apparatus unique key embedded upon commercialization. Further, the key storage function 1356 receives a session key from an external function such as the authentication function 131 and stores the session key. Then, the key storage function 1356 passes such keys in response to a request from the cryptography function 1355.

When the transmission server 13 tries to acquire a content from the receiving server 12, the content management function 133 sends a requesting message through the communication function 132 and receives an encrypted content from the communication function 132.

Then, for example, when the receiving server 12 acquires content data as data for transmission, the cryptography processing function 135 uses the decryption key received from the authentication function 131 to decrypt the content data received in accordance with a predetermined transfer protocol. Then, the cryptography processing function 135 re-encrypts the received content data except timestamps using the apparatus unique key and stores the re-encrypted content data into the content storage function 134.

On the other hand, for example, when the receiving server 12 acquires content data as content data for recording on a DVD (Digital Versatile Disk) or the like from the receiving server 12, the cryptography processing function 135 uses the decryption key received from the authentication function 131 to decrypt the content data received in accordance with a predetermined transfer protocol. Then, the cryptography processing function 135 re-encrypts all of the decrypted content data including the timestamps using the apparatus unique key and stores the re-encrypted content data on a DVD or the like. Consequently, the DVD or the like on which the content data re-encrypted with the apparatus unique key are recorded may not be reproduced by any other apparatus. It is to be noted that, where the content data do not have timestamps added thereto, all of the content data are re-encrypted with the apparatus unique key.

If the transmission server 13 receives a content request from the client or the like through the communication function 132, then the content management function 133 extracts the content from the content storage function 134, causes the cryptography processing function 135 to decrypt the content except the timestamps and then re-encrypt the content into a content for transfer, and sends the re-encrypted content through the communication function 132.

Here, if the transmission server 13 receives a time base seek request from the opposite party of communication such as the client 14, then the transmission server 13 successively searches for the timestamps in the content storage function 134 and causes the cryptography processing function 135 to decrypt content data beginning a portion (TS packet) which includes a desired position designated by the request. Consequently, the content at the desired position can be provided rapidly to the client 14 or the like.

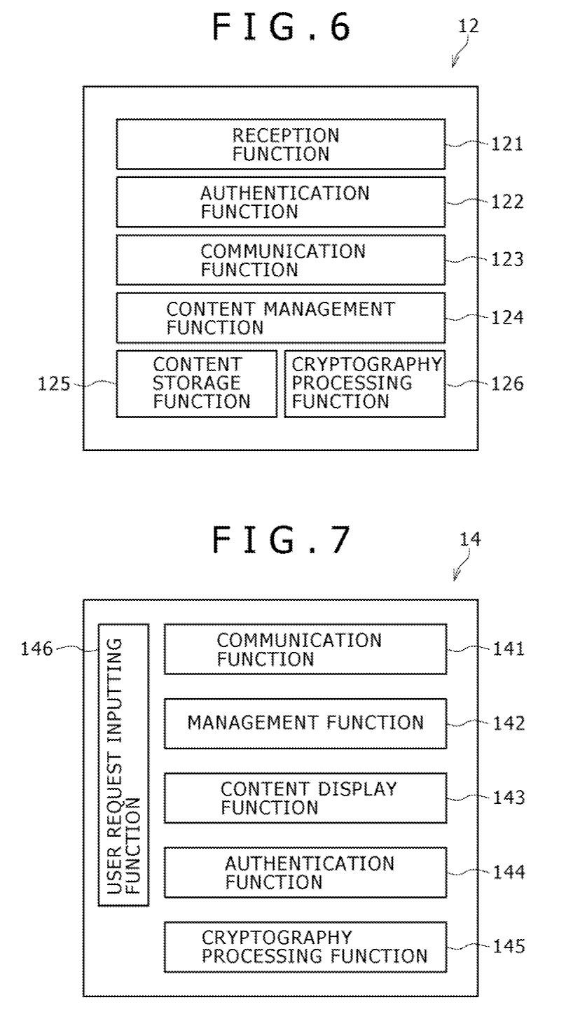

FIG. 6 shows a configuration of the receiving server 12. The receiving server 12 has a basically similar configuration to that of the transmission server 13. Thus, detailed description of similar components of the receiving server 12 to those of the transmission server 13 is omitted herein to avoid redundancy.

Referring to FIG. 6, the receiving server 12 includes a reception function 121, an authentication function 122, a communication function 123, a content management function 124, a content storage function 125 and a cryptography processing function 126.

The reception function 121 receives content data from the broadcast server 11. It is to be noted that the reception function 121 may receive not only content data from the broadcast server 11 but also content data from a digital television broadcast or the like.

The authentication function 122 is similar to the authentication function 131 of the transmission server 13 and cooperated with the receiving server 12 or the client 14 to perform an authentication process.

The communication function 123 is similar to the communication function 132 of the transmission server 13, and receives a message from the transmission server 13 or the client 14 and passes an authentication message to the authentication function 122 but passes any other message to the content management function 124. Further, the communication function 123 sends a message received from the authentication function 122 or the content management function 124 to the transmission server 13 or the client 14.

The content management function 124 operates substantially similarly to the content management function 133 of the transmission server 13. However, the operation of the content management function 124 is different from that of the content management function 133 in that, where a content to be stored is to be encrypted, when a stored content is decrypted, it does not issue an instruction for partial encryption. In particular, when a time base seek request is received from the opposite party of communication, the content management function 124 extracts the content data beginning with the top of the same from the content storage function 125, decrypts the content data, searches for a desired position and sends the content data at the desired position to the opposite party of communication.

The content storage function 125 is similar to the content storage function 134 of the transmission server 13 and performs reading out and writing of information in request to a request from the content management function 124.

The cryptography processing function 126 encrypts or decrypts content data in response to a request from the content management function 124. The cryptography processing function 126 uses the apparatus unique key as the key in the encryption or decryption. A key for encryption and decryption to be used in communication of data with another apparatus is acquired from the authentication function 131. It is to be noted that the key for encryption and decryption (DES, Triple-DES, AES and so forth) of content data is either embedded upon commercialization or produced uniquely for the client 14 using a Hash function or the like from the apparatus ID embedded upon commercialization.

The receiving server 12 receives content data from the broadcast server 11 through the broadcasting network 21 and sends the content data to the transmission server 13 or the client 14 through the home network 22. For example, when content data acquired from the broadcast server 11 are to be sent to the transmission server 13, the receiving server 12 performs an authentication process with the transmission server 13 by means of the authentication function 122. Then, the receiving server 12 decrypts the content data encrypted using the apparatus unique key by means of the cryptography processing function 126 and encrypts the decrypted content data using the session key. Then, the receiving server 12 sends the encrypted content data to the transmission server 13 in accordance with a predetermined communication protocol such as the DTCP-IP or the like.

FIG. 7 shows a configuration of the client 14. The client 14 has a basically similar configuration to that of the receiving server 12. Thus, detailed description of similar components of the client 14 to those of the receiving server 12 is omitted herein to avoid redundancy.

Referring to FIG. 7, the client 14 includes a communication function 141, a management function 142, a content display function 143, an authentication function 144, a cryptography processing function 145, and a user request inputting function 146.

The communication function 141 is similar to the communication function 123 of the receiving server 12, and receives a message from the receiving server 12 or the transmission server 13 and passes an authentication message to the authentication function 144 but passes any other message to the management function 142. Further, the communication function 141 sends a message received from the authentication function 144 or the management function 142 to the receiving server 12 or the transmission server 13.

The management function 142 exchanges a message with the receiving server 12 or the transmission server 13 through the communication function 141 in response to a request from the user request inputting function 146 and performs a process in response to the message.

The content display function 143 receives content data acquired from the receiving server 12 or the transmission server 13 and decrypted from the management function 142 and displays the received content data.

The authentication function 144 cooperates with the receiving server 12 or the transmission server 13 to perform an authentication process. An authentication message is sent and received through the communication function 141, and a key or a certificate which uses the RSA or EC to be used for authentication is embedded in the apparatus upon commercialization. After the authentication is completed, the authentication function 144 shares a session key with the opposite party of communication and passes the session key to the cryptography processing function 145.

The cryptography processing function 145 decrypts encrypted content data received from the receiving server 12 or the transmission server 13 in accordance with a predetermined transfer protocol. A key to be used in the decryption is received from the authentication function 144.

Here, if the client 14 tries to issue a time base seek request which designates a time position to be reproduced to the transmission server 13, then the client 14 sends a content request message, that is, a time base seek request, to the transmission server 13 through the communication function 141. Thus, the client 14 receives encrypted content data from the communication function 141. The encrypted content data are decrypted in accordance with the predetermined transfer protocol by the cryptography processing function 145. The management function 142 issues a request to display the decrypted content data to the content display function 143. Consequently, the content can be reproduced beginning with the time designated by the time base seek request.

Now, communication between servers and between a server and a client is described in detail.

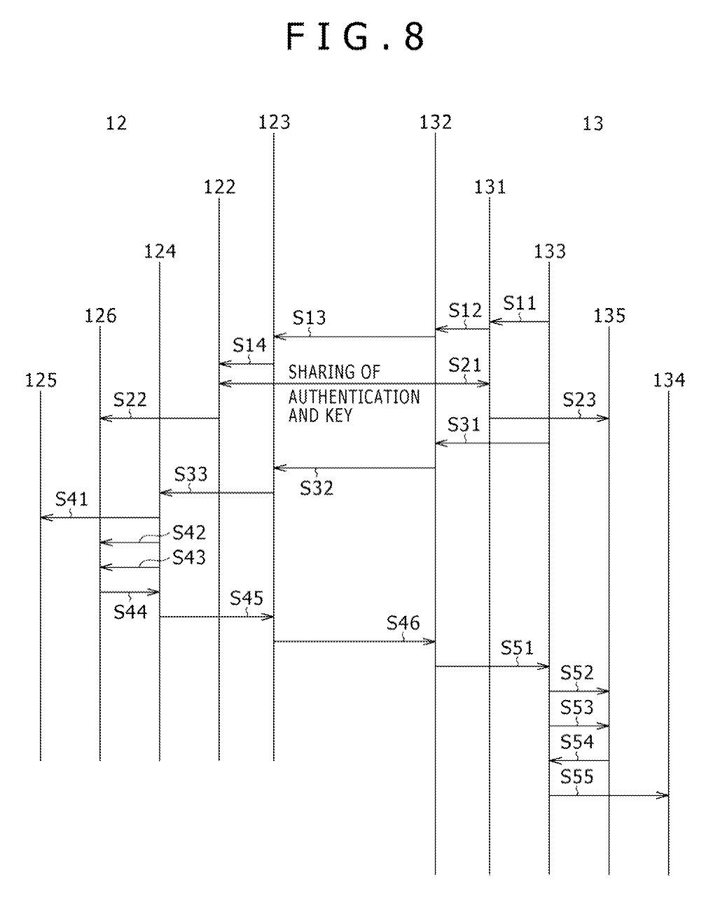

FIG. 8 illustrates a sequence of operations when the transmission server 13 receives a Timed TS from the receiving server 12. It is to be noted that, while the following description is directed to acquisition of a content from the receiving server 12, the acquisition of a content is not limited to this, but a content may be acquired from the broadcast server 11.

The content storage function 125 of the receiving server 12 has stored therein contents with timestamps (Timed TS) which are encrypted with a key unique to the apparatus.

The content management function 133 of the transmission server 13 issues an authentication request to the authentication function 131 in order to acquire a content (step S11). The authentication request is conveyed from the communication function 132 through the communication function 123 of the receiving server 12 to the authentication function 122 (steps S12 to S14).

The authentication function 131 of the transmission server 13 and the authentication function 122 of the receiving server 12 cooperate with each other to perform authentication and key sharing (AKE: Authentication and Key Exchange) through the respective communication functions 123 and 132 (step S21). The ECDH (Elliptic Curve Diffie Hellman) or the like is used for the processes just mentioned. After the key sharing is completed, the authentication functions 122 and 131 set a session key to the respective cryptography processing functions 126 and 135 (steps S22 and S23).

The content management function 133 of the transmission server 13 issues a content request to the content management function of the receiving server 12 through the communication function 132 (steps S31 to S33).

The content management function 124 of the receiving server 12 receives the content request from the transmission server 13 and acquires requested encrypted content data (multiple of a Timed TS or the like) from the content storage function 125 (step S41). Then, the content management function 124 performs mode setting of the cryptography processing function 126 (step S42). In the mode setting, partial encryption for encrypting content data, to which timestamps are added, other than the timestamps or full encryption for encrypting entire data including timestamps is set.

After the mode setting is performed, the content management function 124 issues a decrypting and re-encrypting request of the content data to the cryptography processing function 126 (step S43). The cryptography processing function 126 decrypts the encrypted content data with the apparatus unique key and re-encrypts the decrypted content data with the session key and then passes the re-encrypted content data to the content management function 124 (step S44).

Then, the content management function 124 sends the content data as a response to the content request through the communication function 123 (step S45) to the transmission server 13 (step S46). The transfer protocol upon such sending may be an arbitrary one such as, for example, the HTTP or the RTP. The content management function 124 repeats the processes at steps S41 to S46 until all of the data of the requested content are processed.

The content management function 133 of the transmission server 13 receives the content response through the communication function 132 (step S51) and performs mode setting of the cryptography processing function 135 (step S52). Here, setting of the partial encryption for encrypting the data portion of the content data, to which timestamps are added, other than the timestamps is performed.

After the mode setting is performed, the content management function 133 issues a decrypting and re-encrypting request of the content data to the cryptography processing function 135 (step S53). The cryptography processing function 135 passes the content data decrypted with the session key and partially encrypted with the apparatus unique key to the content management function 133 (step S54). In particular, the cryptography processing function 135 stores the timestamps from within the decrypted content data directly into the content storage function 134 and partially encrypts a succeeding portion (payload) of the content data (up to a portion forwardly of a next timestamp) with the apparatus unique key. The content management function 133 stores the encrypted partial content data into the content storage function 134 (step S55).

The content management function 133 repeats the processes at steps S51 to S55 until all of the data of the requested content are processed.

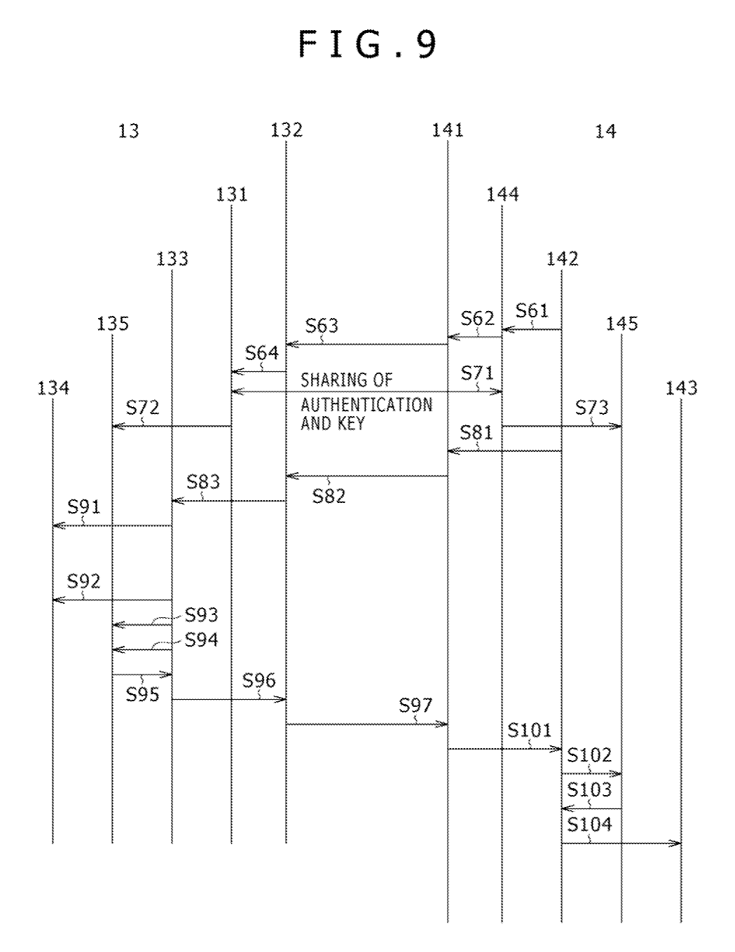

FIG. 9 illustrates a sequence of operations when the transmission server 13 transmits a content to the client 14. Here, the transmission server 13 has stored therein content data, to which timestamps are added, in a partially modified form wherein data portions of the content data other than the timestamps are encrypted as described hereinabove.

The user would use the user request inputting function 146 to issue a content reproduction request. The content reproduction request can designate a reproduction start point in the form of time.

The authentication function 144 cooperates with the transmission server 13 to perform authentication and key sharing in response to the content reproduction request from the user request inputting function 146. The processes at steps S61 to S73 wherein a session key is shared and set to the cryptography processing function 145 after the authentication request is issued to the authentication function 144 are similar to those at steps S11 to S23 described hereinabove with reference to FIG. 8.

After the key is shared, the management function 142 sends a time designation content request to the transmission server 13 through the communication function 141 (steps S81 to S83). The content management function 133 of the transmission server 13 receives the time designation content request from the client 14 and searches for a timestamp in the content storage function 134 based on the designated time (step S91). Here, the content management function 133 repeats a process of reading a next timestamp if the read timestamp is not the desired one. It is to be noted that a next timestamp exists at a fixed interval (for example, the size of the Timed TS). Consequently, the timestamp of the desired time can be searched out rapidly.

After the content management function 133 finds out the timestamp of the desired time, it acquires a partial content of the time designation following the desired position from the content storage function 134 (step S92) and performs mode setting of the cryptography processing function 126 (step S93). Here, setting of partial encryption for encrypting a data portion of the content data, to which timestamps are added, other than the timestamps is performed.

After the mode setting is performed, the content management function 133 issues a partial decrypting and re-encrypting request of the content data to the cryptography processing function 135 (step S94). The cryptography processing function 135 partially decrypts the partially encrypted content data with the apparatus unique key and performs re-encryption with the session key and then passes resulting re-encrypted content data to the content management function 133 (step S95). More particularly, the cryptography processing function 135 partially decrypts the portion (payload) of the partially encoded content data other than the timestamp (up to a portion forwardly of a next timestamp) with the apparatus unique key and then re-encrypts the content data including the timestamp portion with the session key.

The content management function 133 sends the re-encrypted content data to the client 14 through the communication function 132 (step S97). The content management function 124 repeats the processes at steps S92 to S96 until all of the data of the time-designation-requested content are processed.

The management function 142 of the client 14 receives the content data from the time designation position as a time designation content response through the communication function 141 (step S101) and passes the content data to the cryptography processing function 145 (step S102). The cryptography processing function 145 uses the session key to decrypt the content data and passes the decrypted content data to the management function 142 (step S103). Then, the management function 142 issues a content display request to the content display function 143 (step S104). Consequently, the time designated content is displayed on the display section of the client 14.

In this manner, according to the first embodiment, when content data are to be recorded, timestamps are not encrypted. Therefore, even if a request of designation of a reproduction start position of a content is received from the client 14, it is possible to search out a desired position and transmit the content to the client 14 rapidly.

Now, a second embodiment is described. In the second embodiment, when the transmission server 13 fetches content data with a timestamp, it stores bit rate information representing what bit number of data should be processed or sent and received per unit time as meta information and performs a search at a high speed.

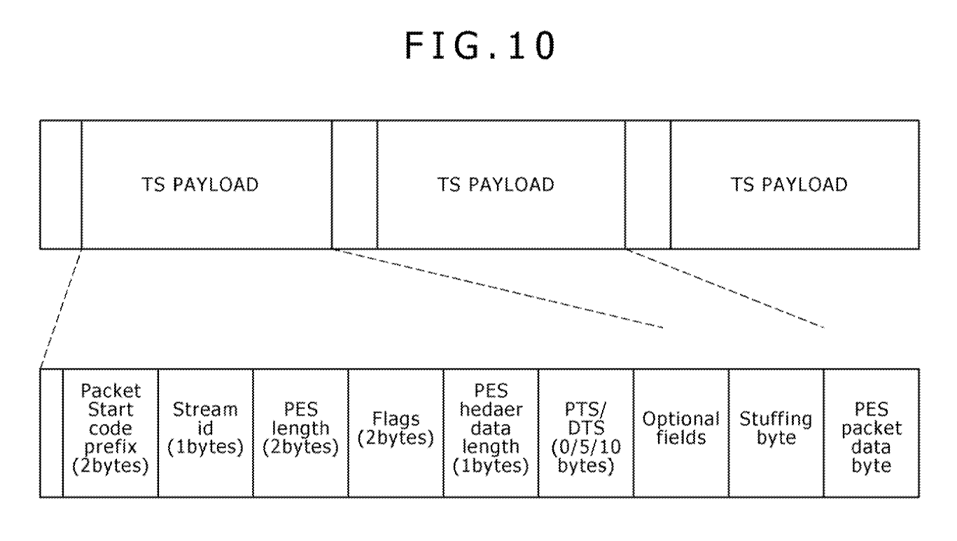

FIG. 10 illustrates a relationship between a TS with a timestamp and a PES (Packetized Elementary Stream) in the MPEG2 system. A PES packet is obtained by packetizing single medium information in a certain unit of presentation and is used as a unit for time management in reproduction of a medium. For example, in the case of video, an encoded data for one picture frame represents one PES packet. The PES packet is a variable length packet and includes, as header information, a packet length, a timestamp, scramble information, copyright information, a CRC (Cyclic Redundancy Check) and so forth. As seen in FIG. 10, a data part of an MPEG2-Timed TS includes divisional parts of a PES packet of the MPEG2.

Here, ES_rate flag in Flags of the PES packet indicates whether or not bit rate information is included. In the case of True, a bit rate is included in one field of Optional Fields. The bit rate information is 22 bit unsigned integer, and the unit thereof is 50 bytes/second.

Accordingly, the transmission server 13 has a decoding function of analyzing bit rate information. Thus, when content data are to be stored, the transmission server 13 analyzes the bit rate information and stores the bit rate information as meta information. Consequently, the transmission server 13 can estimate a rough position of desired content data from time designated from the client 14. Therefore, the transmission server 13 can refer to a timestamp to specify an accurate position.

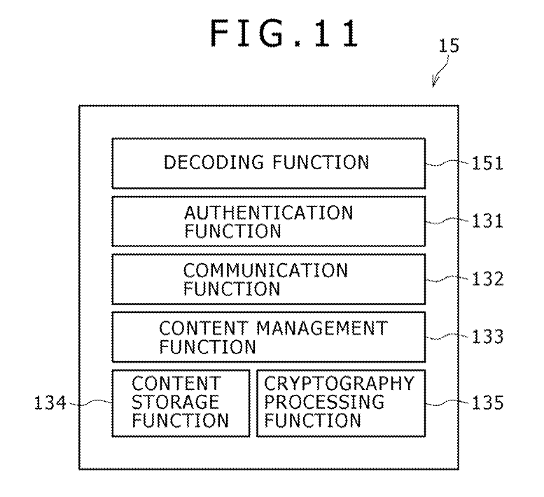

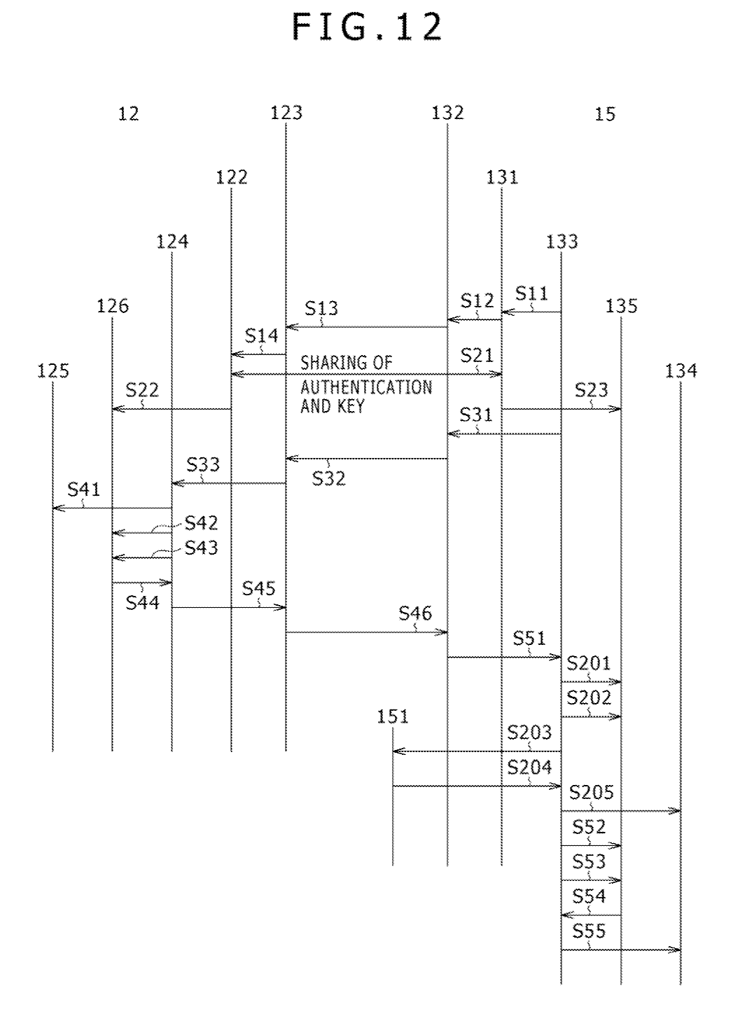

FIG. 11 shows a configuration of a transmission server 15 with a decoding function which analyzes bit rate information. It is to be noted that description of those components of the transmission server 15 with a decoding function which are similar to those of the transmission server 13 is omitted herein to avoid redundancy. Referring to FIG. 11, the transmission server 15 with a decoding function shown includes a decoding function 151, an authentication function 131, a communication function 132, a content management function 133, a content storage function 134 and a cryptography processing function 135.

The decoding function 151 analyzes a PES packet and checks the ES_rate flag in the Flags. Then, if the ES rate flag is True, then the decoding function 151 analyzes the inside of the Optional Fields to acquire bit rate information.

The content management function 133 stores the bit rate information acquired by the decoding function 151 as meta information of the content data into the content storage function 134.

FIG. 12 illustrates a sequence of operations when the transmission server 15 with a decoding function acquires a Timed TS from the receiving server 12. It is to be noted that the fetching process of content data is similar to that of the sequence described hereinabove with reference to FIG. 8 except that it additionally includes a sequence of operations for bit rate acquisition. Thus, description of common processes to those in the sequence of operations of FIG. 8 is omitted herein to avoid redundancy. Further, while the following description proceeds under the assumption that a content is acquired from the receiving server 12, the acquisition of a content is not limited to this, but a content may be acquired otherwise from the broadcast server 11.

The processes at steps S11 to S46 wherein, after an authentication request is issued from the transmission server 15 with a decoding function to the receiving server 12 in order to acquire a content, authentication is performed and content data are sent as a response to the content request from the receiving server 12 to the transmission server 15 with a decoding function are similar to those described hereinabove with reference to FIG. 8.

The content management function 133 of the transmission server 15 with a decoding function receives the content response through the communication function 132 (step S51) and performs mode setting of the cryptography processing function 135 (step S201). Here, setting of partial encryption for encrypting a data portion of content data, to which timestamps are added, other than the timestamps is performed, and setting of raw data extraction for storing bit rate information of the content data as meta information is performed.

After the mode setting is performed, the content management function 133 issues a request for decoding of a portion of the content corresponding to the meta information to the cryptography processing function 135 (step S202) and issues a request for bit rate acquisition from raw data decoded by the decoding function 151 (step S203). The content management function 133 receives a bit rate from the decoding function 151 (step S204) and stores the bit rate into the content storage function 134 (step S205). At this time, the content management function 133 produces a file having a file name wherein a suffix of “.meta” is applied to the same prefix as the corresponding content, converts the value of ES_rate illustrated in FIG. 10 into a unit of bit/second and stores the file name and the converted value of ES_rate as a character string. The later processes at steps S52 to S55 wherein the content management function 133 issues a decrypting and re-encrypting request of the content data to the cryptography processing function 135 and stores the encrypted partial content data into the content storage function 134 are similar to those described hereinabove with reference to FIG. 8.

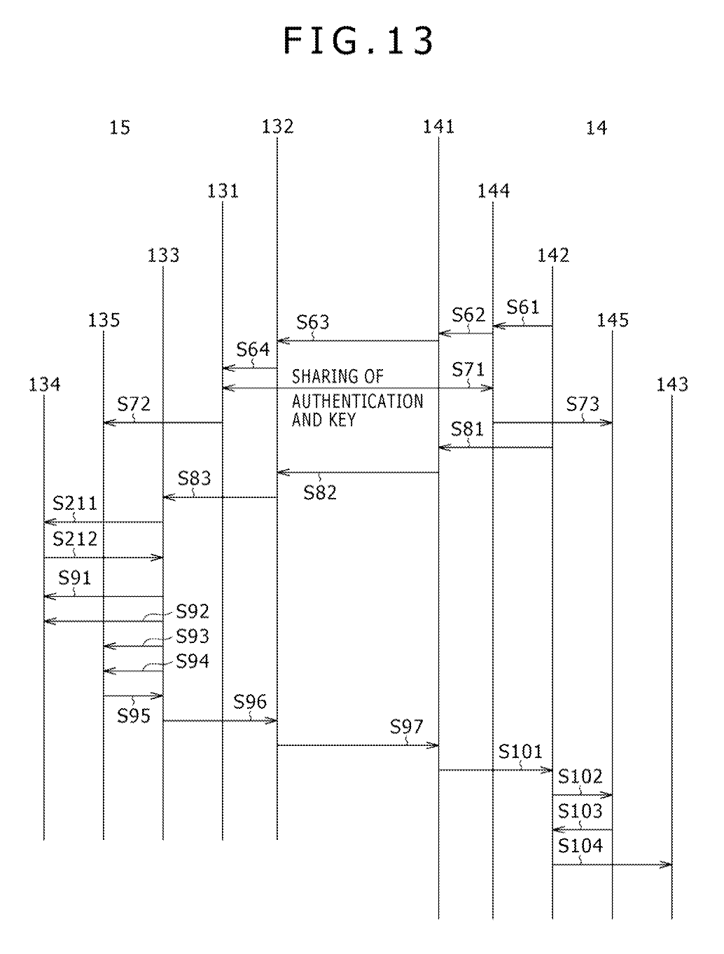

FIG. 13 illustrates a sequence of operations when the transmission server 15 with a decoding function transmits a content to the client 14. Here, the transmission server 15 with a decoding function has stored therein content data, to which timestamps are added, in a partially modified form wherein data portions of the content data other than the timestamps are encrypted as described hereinabove. Further, the transmission server 15 with a decoding function has stored therein bit rate information which represents what bit number of data should be processed or sent and received per unit time as meta information.

The processes at steps S61 to S83 wherein, after a content reproduction request is issued from the client 14, authentication is performed and a time designation content request is sent to the transmission server 15 with a decoding function are similar to those described hereinabove with reference to FIG. 9.

After the time designation content request is received from the client 14, the content management function 133 of the transmission server 15 with a decoding function issues a request for meta information to the content storage function 134 (step S211), and acquires bit rate information from the content storage function 134 (step S212).

Then, the content management function 133 calculates a rough position of the time designation from the content data stored in the content storage function 134 based on the bit rate information and starts seeking (search) for the content position from the rough position (step S91). If the read out timestamp at the rough position is not a desired timestamp, then the content management function 133 decides based on a relationship in magnitude between the desired timestamp and the read out timestamp whether or not a timestamp to be read out next is earlier or later and then reads out the next timestamp. This is repeated until the desired timestamp is searched out. By using the bit rate information, the desired timestamp can be searched out further rapidly.

Thereafter, processes by the content management function 133 of acquiring the partial content of the time designation following the desired position from the content storage function 134, performing partial decryption and re-encryption and sending resulting data to the client 14 are executed at steps S92 to S97 and processes by the client 14 of receiving and decrypting the content data from the time designation position and displaying the content data on the display section are executed at steps S1101 to S104 similarly as in the processes described hereinabove with reference to FIG. 9.

In this manner, according to the second embodiment, when content data are to be recorded, in order to acquire bit rate information, when a request for designation of a reproduction start position of a content is received from the client 14, it is possible to calculate a rough position based on bit rate information and search out a desired position rapidly.

In the second embodiment described above, when the transmission server 15 with a decoding function is to store content data, it analyzes bit rate information and stores the bit rate information as meta information. However, where the receiving server 12 has bit rate information as meta data, the bit rate information may be acquired from the receiving server 12 upon acquisition of a content. The receiving server 12 and the transmission server 13 in this instance have a configuration similar to that of the functional blocks shown in FIGS. 6 and 4, respectively.

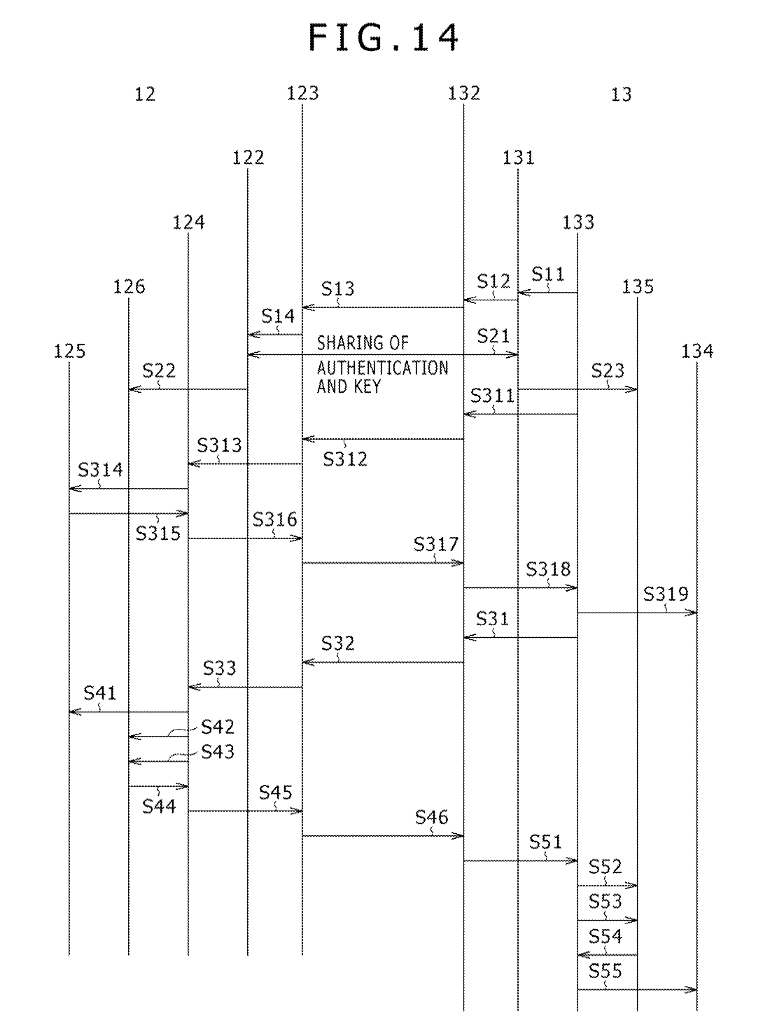

FIG. 14 illustrates a sequence of operations when the transmission server 13 acquires a Timed TS from the receiving server 12. It is to be noted that the fetching process of content data is similar to that of the sequence described hereinabove with reference to FIG. 8 except that it additionally includes a sequence of operations for bit rate request to the receiving server 12. Thus, description of common processes to those in the sequence of operations of FIG. 8 is omitted herein to avoid redundancy. Further, while the following description proceeds under the assumption that a content is acquired from the receiving server 12, the acquisition of a content is not limited to this, but a content may be acquired otherwise from the broadcast server 11 if the transmission server 13 has bit rate information as meta data.

The processes at steps S11 to S23 wherein, after an authentication request is issued from the transmission server 13 to the authentication function 131 in order to acquire a content, a session key is shared are similar to those described hereinabove with reference to FIG. 8.

After the session key is shared, the content management function 133 of the transmission server 13 sends a bit rate request to the receiving server 12 through the communication function 132 (steps S311 to S313). The content management function 124 of the receiving server 12 receives the bit rate request and issues a request for meta information to the content storage function 125 (step S314). Then, the content management function 124 acquires the bit rate information from the content storage function (step S315). The content management function 124 sends the bit rate information as a reference from the communication function 123 to the transmission server 13 (steps S316 and S317).

The content management function 133 of the transmission server 13 receives the bit rate information (step S318) and stores the bit rate information into the content storage function 134 (step S319).

The processes at steps S31 to S46 and the processes at steps S51 to S55 are similar to those described hereinabove with reference to FIG. 8. Concretely, the processes at steps S31 to S46 wherein, after a content request is issued from the transmission server 13 to the receiving server 12, content data are sent as a response to the content request from the receiving server 12 to the transmission server 13. The processes at steps S51 to S55 wherein the content management function 133 issues a decrypting and re-encrypting request of the content data to the cryptography processing function 135 and stores the encrypted partial content data into the content storage function 134

According to an embodiment, speedup of a time base seeking operation of an encrypted content with a timestamp can be implemented.

While preferred embodiments have been described using specific terms, such description is for illustrative purpose only, and it is to be understood that changes and variations may be made without departing from the spirit or scope of the following claims. For example, while, in the embodiments described above, bit rate information is acquired through an analysis of a PES packet, the acquisition of bit rate information is not limited to this, but an average bit rate may be determined, for example, from a timestamp of a Timed TS and the full file size of content data. By this, even if the bit rate information of a content varies depending upon the time position, an accurate rough position can be specified.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A content transmission server which records encrypted streaming data of a predetermined unit to which time information is added and transmits the encoded streaming data to a client, comprising:
a decryption section configured to decrypt the encrypted streaming data of the predetermined unit to which the time information is added;
a local encryption section configured to locally encrypt the streaming data decrypted by said decryption section;
a storage section configured to store the streaming data locally encrypted by said local encryption section; and
a transmission section configured to transmit the encrypted streaming data to the client, wherein
said local encryption section partially encrypts, when said local encryption section stores the encrypted streaming data as encrypted streaming data for transmission into said storage section, a portion of the partially encrypted streaming data stored in said storage section other than the time information using an apparatus unique key,
said storage section stores the partially encrypted streaming data and the time information, and
said transmission section searches in response to a request for encrypted streaming data at a desired time position from the client, the partially encrypted streaming data stored in said storage section based on the time information, partially decrypts the partially encrypted streaming data at the desired time position using the information unique key, re-encrypts the partially decrypted streaming data with a predetermined protocol and transmits the encrypted streaming data to the client.

2. The content transmission server according to claim 1, wherein said transmission section determines a rough position of the desired time position based on bit rate information of the encrypted streaming data and searches the partially encrypted streaming data based on the time information.

3. The content transmission server according to claim 1, further comprising a bit rate information acquisition section configured to acquire bit rate information from the streaming data decrypted by said decryption section.

4. A content transmission method for recording encrypted streaming data of a predetermined unit to which time information is added and transmitting the encoded streaming data to a client, comprising the steps of:
decrypting the encrypted streaming data of the predetermined unit to which the time information is added;
locally encrypting the streaming data decrypted by the decryption step;
storing the streaming data locally encrypted by the local encryption step into a storage section; and
transmitting the encrypted streaming data to the client, wherein
the local encryption step includes partial encrypting, when the encrypted streaming data is stored as encrypted streaming data for transmission into said storage section, of a portion of the partially encrypted streaming data stored in said storage section other than the time information using an apparatus unique key,
the storage step includes storage of the partially encrypted streaming data and the time information, and
the transmission step including searching, in response to a request for encrypted streaming data at a desired time position from the client, of the partially encrypted streaming data stored in said storage section based on the time information, partial decryption of the partially encrypted streaming data at the desired time position using the information unique key, re-encryption of the partially decrypted streaming data with a predetermined protocol and transmission of the encrypted streaming data to the client.
